(19) United States
(12) Patent Application Publication
(10) Pub. No.: US 2016/0189317 A1
(43) Pub. Date: Jun. 30, 2016

(54) Personalized Patient Experience System

(71) Applicant: John PAPANDREA, Trabuco Canyon, CA (US)

(72) Inventor: John Papandrea, Trabuco Canyon, CA (US)

(21) Appl. No.: 14/912,389

(22) PCT Filed: Aug. 15, 2014
(86) PCT No.: PCT/US14/51369

§ 371 Date: Feb. 16, 2016

Related U.S. Application Data
(60) Provisional application No. 61/866,756, filed on Aug. 16, 2013.
(60) Provisional application No. 61/944,949, filed on Feb. 26, 2014.

(51) Int. Cl. G06Q 50/00; G06F 19/00

(52) U.S. Cl. CPC G06Q 50/01; G06F 19/326

(57) ABSTRACT

A system and method to monitor, update, and manage a personalized patient experience. The system permits the patient to control the receipt and dissemination of information and data from one or more sources to one or more outputs.

### PRIORITY

The present application claims priority benefit to U.S. Provisional Application No. 61/866,756, filed Aug. 16, 2013, and U.S. Provisional Application No. 61/994,949, filed Feb. 27, 2014, the entirety of which are incorporated by reference herein.

### BACKGROUND

Patients experiencing serious diseases undergo a journey through diagnosis, treatment, and recovery. Hopefully, most patients experiencing serious illness undergo this journey only once. However, given the limited encounter, the patient generally does not have the experience, resources, or knowledge to understand and respond appropriately to their condition or symptoms. Their doctor is generally their next best source of information. However, encounters with experienced practitioners are generally limited in time and focused on the specific agenda of the doctor. The patient may not be aware of what information is relevant to the doctor. Therefore, candid and complete disclosures by a patient to fully inform a doctor is also generally limited because of time, focus, present concerns and priorities of both patient and doctor, the bias of the patient to identify relevant or necessary information, the sensitivity of the patient to disclose personal, intimate, and embarrassing information, as well as any other number of interferences and distractions. In addition, the care may be spread across multiple practitioners with various systems and communication procedures, such that relevant information may not be fully, efficiently, and timely transmitted from specialists to the primary practitioner. Therefore, in many situations, the practitioner is not even in a position to fully inform a patient of their condition or the associated symptoms that are likely to follow during the progression of their treatment.

The patient may look to other sources of information. In this case, the patient may be faced with a plethora of information from their healthcare provider, the internet, and friends, family, and support or social groups. The source of the information may be unverified, unreliable, and/or irrelevant to the particular patient. The information may include treatment options, medication options, medication interactions and side effects, coping techniques, social and support materials, etc. Especially when information may be outdated, or in conflict, the patient may easily become overwhelmed and confused.

A patient also faces a number of social and emotional considerations and effects during treatment, which may or may not be additionally affected by their condition, their medications, their social situation, their support structure, etc. These factors outside of the actual presence, progress, and treatment of their disease may be completely overlooked by a patient, practitioner, and others. The patient's mental health, social structure, work, and other life interactions may substantially influence a patient's recovery. By overlooking relevant details of the patient's life, the patient may not benefit from a complete recovery plan.

Managing both the clinical and social information received during the long term treatment undergone by a patient is daunting. In many cases, the patient may have one or more persons assisting in their treatment. For example, a geographically close friend may be monitoring an emotional state of the patient, while a family member may be helping with medications and/or scheduling appointments. Coordinating the information among more than just the patient adds additional complications, stress, and possible oversight. Thus, the success of the patient treatment plan can be hampered.

### BRIEF SUMMARY

The methods and systems described herein may be used by a patient as they journey through an illness lifecycle. Embodiment may be used to supply and retrieve information relevant to the specific stage, knowledge, illness, conditions, or other attributes of the patient, illness, and lifecycle stage when it is most relevant to the patient, such as proximate to the related stage of the illness in which the information pertains. Embodiments may also be used to disseminate and retrieve information to other users identified and related to the patient, such as a practitioner, lab or test facility, pharmacy, or one or more persons creating a social network such that the users may provide the necessary support to the patient in a convenience and efficient manner. The system may track or update the status of the patient along the illness lifecycle, such that the system provide relevant information to a patient associated with one or more specific attributes of the patient, patient illness, illness lifecycle stage, etc.

According to embodiments provided herein, a personalized patient experience system, including a webpage resident on a server or a native mobile application resident on a client device configured to communicate with the server is provided. The webpage or native mobile application is configured to receive input from a patient through one or more interfaces and communicate the received input to the server, where the server is configured to cooperate with a database over a network. The system may include a first module to receive information from the patient about an illness of the patient, and a second module to disseminate information to one or more users about the illness of the patient. The system may monitor the received information to determine what information should be disseminated to each user.

According to embodiments provided herein a method of assisting a patient through a lifecycle of an illness is provided. The method may include: receiving from the patient specific patient information including patient attributes and illness progression attributes into a personalized patient experience system accessed through an electronic mobile device; determining a progression of the patient along the lifecycle of the illness; providing patient specific information about the illness commiserate with the progression of the patient along the lifecycle of the illness; updating the progress of the patient along the lifecycle to an updated progression upon receiving update information through the electronic mobile device; and providing updated patient specific information about the updated progression upon or after receiving update information.

### BRIEF DESCRIPTION OF THE DRAWINGS

FIG. 1 illustrates a diagram of an embodiment of a client-server network environment to implement the personalized patient experience system.

FIG. 2 illustrates an exemplary flow diagram of an embodiment of the interaction of the users and system to update one or more input sources from the patient to the medical providers and disseminate the information to one or more social networks.

FIG. 3 illustrates an exemplary illness lifecycle 300 in which a patient may find themselves.

FIG. 4 illustrates an exemplary method of using the application to assist a patient using one or more features of the application described herein.

FIGS. 5A-D illustrate exemplary application modules and user interfaces corresponding to the method of FIG. 4.

FIG. 6 illustrates an exemplary entry survey map that may be navigated to determine the stage of a patient's breast cancer upon initiating or setting up the application.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Embodiments described herein may be used to provide patients a comprehensive application and associated method to accompany them through their illness lifecycle. For example, an illness lifecycle may include a suspicion of illness, examination, diagnosis, treatment, and surveillance. Embodiments described herein may be used to track a patient through the lifecycle and provide and anticipate the progression of the patient illness in the form of one or more modules configured to provide the patient information and assistance in various forms for their present stage and one or more anticipated future stages tailored to the specific patient progression. Embodiments described herein may be used to efficiently consolidate the patient's symptoms and progress such that information may be entered, retrieved, shared, presented, disseminated, or otherwise used by the patient for tracking, diagnosis, reminders, education, support, or any other purpose to assist the specific patient through their illness lifecycle.

Although embodiments of the invention may be described and illustrated herein in terms of cancer patients, it should be understood that embodiments of this invention are not so limited, but are additionally applicable to other long term illnesses or conditions in which features of the present system may provide patient support, information, efficiency, or other benefits. For example, other conditions may include Alzheimer's, diabetes, tumors, pulmonary conditions, cardiac conditions, etc. Furthermore, although embodiments of the invention may be described and illustrated herein in terms of a mobile application, it should be understood that embodiments of the invention are also applicable to other interfaces, such as websites, portals, dedicated electronic and monitoring devices, and configurations in which the one or more persons may exchange information conveniently and efficiently.

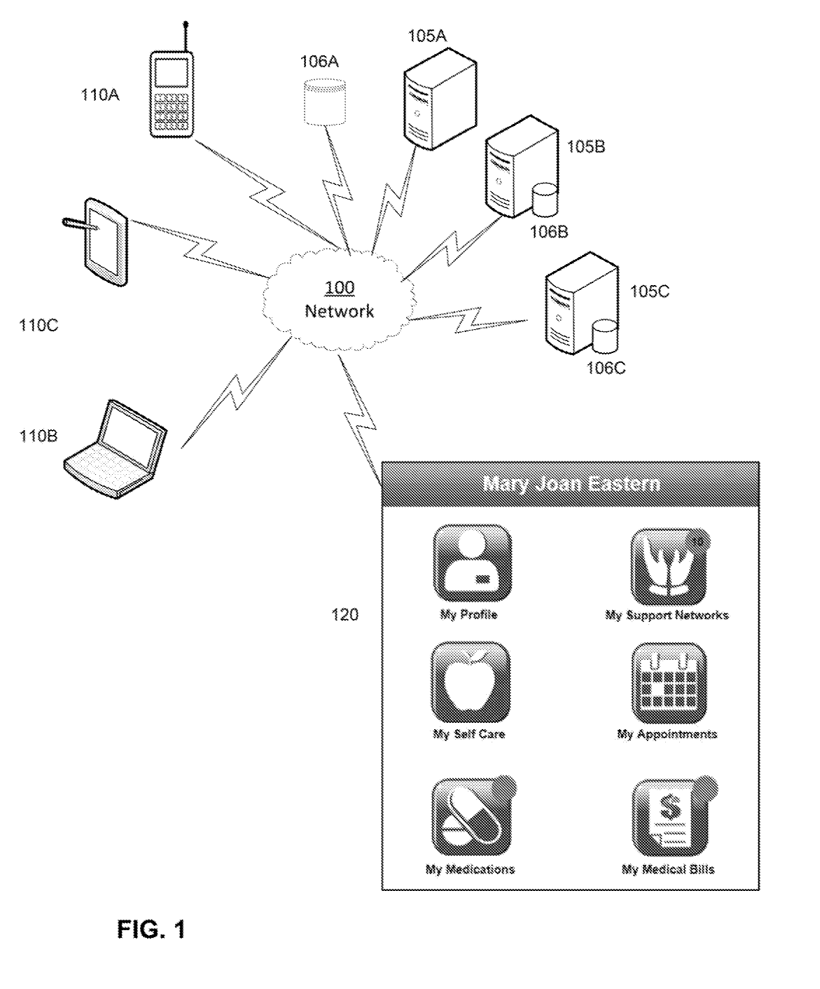

FIG. 1 illustrates a diagram of an embodiment of a client-server network environment to implement the personalized patient experience system. An application resident on the client device 110A-110C communicates over a network 100 with one or more servers 105A-105C and their databases 106A-106C. This client device-server system is configured to enable a user of the client device 110A-110C to implement the personalized patient experience system to assist the patient during their progression of their illness, including, but not limited to receiving information personally relevant to their present condition, symptoms, medications, treatments, physical and mental states, etc.; logging, receiving, displaying, and/or tracking one or more parameters, symptoms, or attributes of their physical or mental condition; communicating, sharing, or discussing information with one or more persons of a social network; coordinating other experiences of an extended illness such as receiving and paying bills; scheduling, reminding, or notifying one or more persons of appointments; reminding, logging, or refilling medications; or any combination thereof. The client devices such as a smart phone 110A, personal digital assistant/tablet 110B, laptop computer 110C may have a browser application resident along with one or more client applications scripted to run the personalized patient experience application operations and cooperate with the server.

The database, such as a first database 106A, maintains the database for storing one or more attributes of the personalized patient experience. When the server 105A is an internet site, the server may be comprised of at least one or more servers and cooperating databases. This new, simple, patient-controlled paradigm for coordinated, consolidated, networked, and socially networked patient care enables anyone to easily receive and disseminate relevant, accurate, and pertinent information in a timely and efficient manner. One or more modules, such as a client application on the mobile client device or server applet resident on the server, may be configured to present an interface to support the intake and output of information for one or more of the functions described herein. The client application has code scripted to present one or more user interface templates that are user customizable, have one or more prompted input fields, and is configured to work with a browser and a remote server. The server applet works with a browser application resident on the client device and serves one or more web pages 120 to the client device with the resident browser.

Referring to FIG. 1, each client device 110A-110C can communicate the content entered into the various user interface fields to set or populate one or more attributes of the database over the network to the server 105A-105C potentially located on the World Wide Web. A software program resident on the server, such as the first server 105A, takes in the entered details. The backend server aggregates the information. The information is passed to the database. The server then checks the database to see whether content was updated, the type of content update, who entered the content, who initiated the entry, who should receive notices regarding the entry, whether the entry implicates other information that should be made available to one or more users, etc. and sends corresponding notices and information to the one or more associated users in response to the received information. Thus, a software program resident on the server is coded to take in the details from one or more users, assess the information received, and perform specific functions in response to the received information. The server then feeds this information back to each client device to be displayed on a display screen of that client device as well as feeds this information back to one or more other networked users, such as the social network, and/or healthcare provider. The web application on the server can cooperate over a wide area network, such as the Internet or a cable network, with two or more client machines each having resident applications.

In an embodiment, the software used to facilitate the protocol and algorithms associated with the process can be embodied onto non-transitory machine-readable medium. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; DVD's, EPROMs, EEPROMs, FLASH, magnetic or optical cards, or any type of media suitable for storing electronic instructions. The information representing the apparatuses and/or methods stored on the machine-readable medium may be used in the process of creating the apparatuses and/or methods described herein. Any portion of the server implemented in software and any software implemented on the client device are both stored on their own computer readable medium in an executable format. Embodiments described herein, such as modules, applications, or other functions may be configured as hardware, software, or a combination thereof. The configuration may be stored one a single dedicated device such as an application locally resident and executed on mobile devices 110A-11C configured to communicate over a network or across many devices such as a website hosted across one or more servers 105A-C retrieving information across one or more databases 106A-C, to communicate across a network 100 to a local device, such as laptop 110B, or any combination thereof.

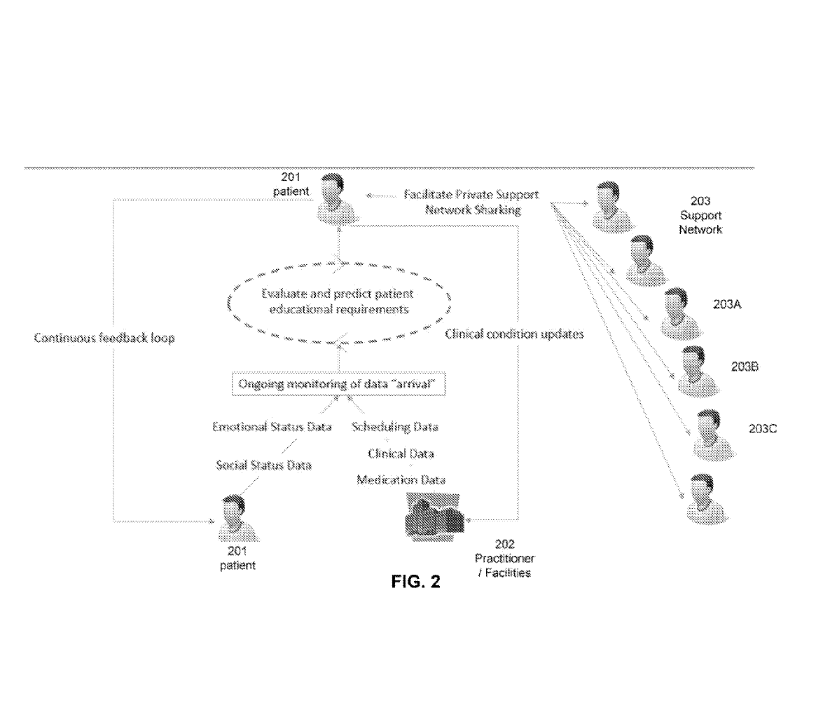

FIG. 2 illustrates an exemplary flow diagram of an embodiment of the interaction of the users and system to update one or more input sources from the patient to the medical providers and disseminate the information to one or more social networks.

At the lower left, the system interfaces with a patient 201 to retrieve patient specific information on a periodic basis. The patient may interface through one or more modules to update information such as specific conditions, symptoms, physical or emotional assessments, events, social inputs, etc.

At the lower right, the system may interface with one or more practitioners and/or facilities 202 that interact with the patient in treating the patient's illness. The one or more practitioners and/or facilities may interface through one or more modules to update information such as scheduling data, clinical data, medication data, or other medical data.

Along the right side, the system interfaces with one or more support networks 203 to permit reception and dissemination of information from the system to other individuals. The patient can control the access provided to the support network. For example, friends 203A and family 203B may be given unlimited access to the news feeds and educational information supplied by the system to the patient to educate the support network on the patient's condition and treatment. One or more persons from the support network may be given additional access or alerts to other data from the system. The support network and patient can communicate back and forth through the system. The support network may also include one or more public support groups 203C to connect the patient with others experiencing or having experienced similar illnesses.

The system comprises algorithms that evaluate and monitor information as it enters and passes through the system. The system then compares changes in the respective data to determine whether information should be requested or disseminated to the patient, or one or more other providers or users. For example, if the patient indicated or responded to one or more questions that indicated a lack of knowledge on a specific topic, such as insomnia, the system may respond by providing educational content on how the patient might address the issue.

As another example, when the pharmacist or healthcare provider supplies a new prescription to the system, a notice may be provided to the patient and or one or more support network persons that a prescription is available for pickup. The system may also disseminate information about the prescription including its appearance, side effects, treatment purpose, etc. to the patient and/or one or more members of the private support network. The system may then, in an appropriate time, prompt the patient to confirm whether the medication was timely taken. If the medication was or was not taken, the system may send an alert to one or more members of the private support network. The user may then select to perform a self assessment, which may ask general questions of fitness and health such as sleep, energy, etc. or may provide a dynamic questionnaire based on other data received in the system. Therefore, since the system is aware of the medication the patient is on, part of the daily assessment may be to monitor for known side effects such as depression, constipation, etc. If the patient then indicates an adverse side effect, a notice may be sent to the healthcare provider and/or pharmacist. The system may operate on a continuous feedback loop, such that information from one input may trigger requests for additional inputs form one or more other input sources and or disseminate information to one or more output sources.

A user may communicate with the database over a network through a number of interfaces. For example, a user may navigate to a website that is resident on a server and accessed through a public or private network, such as the internet. Alternatively, a user may access a mobile application resident on a client device, such as a mobile device (smart phone, tablet, laptop, etc.) or desktop, where the mobile application communicates with the database over a network. The website or native mobile application may be configured to receive the input from a user through one or more user interfaces and send that received information over the network to the server. Alternatively, or in addition thereto, the system may be configured through one or more interfaces to communicate directly with another user's electronic system. For example, if a pharmacist enters a prescription into an electronic system, the file and/or patient may be flagged as participating in embodiments of the personalized patient experience system. The system according to embodiments described herein may then poll the electronic system of the pharmacist to determine if any new information has been entered for a respective patient within the system. If found, the system may retrieve the updated information directly from the electronic system of the pharmacist. A prompt or notice may be provided to the pharmacist requesting or alerting the disclosure of the respective information to the system. Once permitted, the system retrieves the information, communicates with the network and/or the server to update the database and process updates, alerts, and other functions as described herein.

The server may then be configured to cooperate and communicate with the database to read, write, and query respective information from the database. Thus, the invention is not intended to be limited to an application and/or server interface, but may comprise one, the other, or any combination thereof to permit one or more users to interface with the system. Moreover, the system components performing the respective steps and/or modules may be combined, divided, integrated, or separated such that one or more servers, client devices, computers, networks, databases, etc. may be used to accomplish the described features. Accordingly, the system is not intended to be limited to the exemplary embodiments described herein, but generally comprises a system to permit information entry from one or more sources, monitor the receipt of that information, and update one or more users about other available information based on the received information.

A system to facilitate social networking and consolidate, coordinate, and manage clinical information and social information is described. The system permits inputs from a number of sources, such as the patient, the one or more healthcare providers, doctors, and/or facilities, pharmacists, friends and family, other reference and informational sources, support structures, and any combination thereof. The system may continuously, periodically, or upon a triggering event monitor the arrival of information to update one or more input sources and/or output sources of relevant changes and/or relevant information to the patient. The system permits the patient to disseminate the information over a social platform to inform one or more networked users of one or more classes of information and/or changes.

The system is configurable such that the patient can set the dissemination levels for the one or more network users individually or as a group, provide automatic, periodic, or upon request notices to themselves, or others. The feedback loop between the patient, medical sources of data and information, and social network provides the most relevant and accurate information to everyone at a relevant and efficient time.

In an embodiment, an application resident on a client device communicates over a network with a server and database. This client device-server system is configured to enable a user of the client device to communicate and collaborate directly with their physicians, case managers, or cancer navigators; facilitate and maintain complex treatment programs; initiate and conduct personalized self-care activities; undertake self-test reporting; consume personalized multi-media educational content; manage appointments and pay bills, for example. The system may include one or more modules, such as an application on the client device or resident on the server. Exemplary modules may include one or more of the following exemplary modules:

A mapping module is configured to determine the type of illness and the progression of the illness for the present patient. For example, the system may determine where the patient is on an illness lifecycle. The mapping module may be used to update the progress of the patient through the illness lifecycle by requesting specific information from the patient at relevant times or by communicating or receiving information from one or more other modules described herein. Therefore, the mapping module may be used to continually or periodically update the system to the specific progress and condition of the patient to address their individually identified needs.

A personalized patient medication management module is configured to present a user interface to retrieve and disseminate information regarding medication management, including: reminders, alerts, and tracking for medication times and dosages; purposes and description of medications; side effect information and tracking; prescription management including renewal management, drug store integration, and conflict coordination. For example, a user may identify one or more prescribed medications by entering the name, dosage, frequency, etc. into one or more text fields on the user interface. The information may alternatively be entered and/or uploaded from either the patient's pharmacy and/or healthcare provider. The module may provide a list of the entered medications and provide an indicator to the user when new information is available and/or needed for one or more of the identified medications. Therefore, when information about a medication is available, a user may access the details about symptoms, purpose, side-effects, appearance, etc. The user may also be notified when a dosage is required and prompt and/or permit the user to enter or confirm that the appropriate dosage was taken. The module may track the remaining dosages and/or remaining pills before refill. The system may prompt and/or permit the user to refill a prescription when the available dosage gets low.

A scheduling management module is configured to present a user interface to retrieve and disseminate information regarding scheduling, rescheduling, and other scheduling management functions. The module may present a user with an interface identifying and/or alerting the user to scheduled appointments and may include the doctor, location, date, time, purpose, etc. The module may coordinate with the client device to retrieve location information and provide directions, maps, etc. to the appointment location. The module may access a physician and/or facility database to coordinate phone numbers and addresses for various appointments. For each appointment reminder, the user may be provided a direct interface to call the appointment facility, confirm the appointment, and/or reschedule the appointment. Thus, reducing the clutter and confusion associated with multiple providers, facilities and contacts. If the user chooses to change an appointment, the user may be presented with an interface of one or more preferabe appointment times, such as dates, morning and/or afternoon, etc. Similarly, the user may request a new appointment and indicate its urgency, one or more preferred dates and/or times, and/or other pertinent information about the request. For either a reschedule or a new appointment, the module then communicates over the server and submits the appointment request to the healthcare provider and/or facility. The module may communicate directly with the facility's and/or healthcare provider's scheduling system, and/or submit the request for confirmation in a number of ways, such as by email request, fax request, etc. The healthcare provider, and/or facilities may confirm the appointment as dictated by its system. The provider or facility may automatically communicate with the module to update the patient on the status of the appointment request. Alternatively, the patient, provider and/or facility may separately interface with the module to confirm an appointment request. In either case, the module is updated and the appointment made. The module may then notify the patient of the new appointment time and request final confirmation and/or verification to supply to the provider and/or facility. The module may provide the user with the same options of rescheduling, cancelling, confirming, mapping, etc. the appointment. The module may coordinate and monitor appointments, such that appointments do not overlap, may account for travel time between locations, or may alert one or more persons of the patient's social network about the appointment. The module may permit the patient, user, or other source to identify one or more actions that must occur before the appointment can occur. For example, if an x-ray is necessary before a care giver appointment, or if testing is done that requires special conditions (for example, fasting) prior to testing, the module may provide alerts and reminders for these events at the appropriate times. The module may track the purpose of an appointment, such that if one appointment relies on another, and the earlier is cancelled or rescheduled, the module may prompt the user to restrict the rescheduling time to prior to the later appointment, or may prompt the user to similarly reschedule and/or cancel the remaining appointments. The scheduling of an appointment may also permit the system to provide the patient and/or their social network pertinent information about the expected event and/or update the patient's lifecycle profile to correspond to the occurrence of an event. For example, if surgery is scheduled, the patient may be provided relevant information about what to expect from the surgery a few days before the surgery, what to expect from recovery proximate the surgery date, or about medications or follow up procedures after the surgery has concluded. The system may also update the progress of the patient through the illness lifecycle to correspond to the event, and therefore continue to provide pertinent information specific to progress of the patient along their illness lifecycle.

A medical bill payment module is configured to present a user interface to retrieve and disseminate information regarding patient accounting systems to allow direct and/or indirect bill payment. The module may track received bills, may permit the user to automatically pay a bill, provide reminders of outstanding bills, call or otherwise notify a bill provider of a disputed bill. For example, the module may communicate with the database to retrieve contact information for one or more of the presented bills to permit the user to directly contact the bill provider and request additional information and/or dispute a payment. The module may present the patient with a list of outstanding bills, payment history, paid bills, etc. The format and presentation may be changed by the user. The module may provide details regarding the date of service, purpose of service, care provider, payment charge break down, account numbers, total due, outstanding invoices, etc. for any one or more providers. The system may indicate whether any one or more invoices are past due. For example, the module may present a list of providers and the associated outstanding balances. If any portion of the outstanding balance is past due, an indicator may be presented to the user, such as a red dot, highlights or otherwise color changed text, bolding, or other stylized indicator, text of overdue or past due, visual or audio indicator. The list of providers may be presented in an order of oldest outstanding balances first, to provide a user a prioritized reference. The module may store patient account information in the database to provide direct payment through an electronic funds transfer, and/or credit card payment. The module may also permit the user to enter payment information on a single use basis, such that the information is not stored at the client, server, and/or database.

A personalized self-care module is configured to present a user interface to retrieve and disseminate information regarding informing, educating, and self-assessing the patient's condition. For example, the module may provide information materials based on one or more attributes entered by the patient, healthcare provider, social network, or other users. Thus, the system may provide reading and/or videos about the patient's diagnosed cancer, prescribed medications, present, past, or potential future emotional and/or physical state, among other information relevant to the patient and the patient's illness lifecycle. The system may continuously, periodically, or upon an indicated event update the provided information to the patient. For example, if a new medication is entered into the personalized patient medication management module, the personalized self-care module may provide additional reading materials on the drug, alternative drugs, associated and/or alternative treatments generally used with the drug, etc. The personalized self-care module may provide clinical, emotional, and support information to the user in response to one or more personalized information entered into the system. The personalized self-care module may also permit the patient to monitor one or more of their own conditions or attributes. The system may prompt the user to assess the quality of a number of factors on a periodic basis, such as daily, weekly, and/or monthly. For example, a patient's sleep quality, lethargy, and/or weight may be monitored daily, while a patient's blood glucose and nutrition is monitored multiple times daily, and a patient's blood pressure is measured weekly or monthly. The system may qualitatively and/or quantitatively track these features. For example, for one or more categories, such as sleep quality, the user may be presented with a range of 1-10 icons or numbers to rate their sleep. In an exemplary embodiment, the user is presented four icons generally depicting bad, poor, average, and good. The icons are both color coded and symbolic of the associated qualitative ranking. Thus, barriers to user interface such as literacy and/or language may be substantially reduced and/or eliminated. The system may also provide one or more text fields, drop down boxes, number indicators, etc. to permit the patient to quantitatively enter information, such as weight, blood glucose, number of hours sleeping, etc. The module may present a history of results to the user, such as through a line graph indicating the successive quality of one or more of the entered conditions. The system may also retrieve information directly or indirectly from one or more sensor devices integrated or coupled to the system. For example, the system may communicate or permit a user to enter information received by a health monitoring system, such as one that tracks activity, sleep, pulse, blood pressure, or other biological or activity condition.

A personalized support network module is configured to present a user interface to coordinate, receive, and disseminate information among one or more individuals or support groups. The module permits the patient to identify different support networks including, for example, family, friends, other survivors, healthcare professionals, public support groups, news lines, clinical trials, etc. The patient can add or identify one or more persons to one or more networks. The support networks may be from one or more private and/or public sources. For example, the module may interface and/or communicate with one or more social media sites such as Facebook, Twitter, etc., to receive feeds from one or more public networks. The patient may also identify one or more individuals to create private support networks. The support networks permit users identified on the respective network to communicate individually or privately with the patient by sending messages between them and the patient or within the group they are associated with. Therefore, comments from one or more sources may be disseminated and communicated on an individual or a group basis. The patient may also permit one or more individual users or groups to receive notices when updates occur within one or more of the modules. For example, if a family member is assisting in appointments, that person may have access to the scheduling management module and/or may receive notices, such as text message or email notices when changes are made through the module. Therefore, a person that does not have access to the module may still receive information from the modules about the patient. Similarly, a neighbor, the same or another individual, or more than one individual may have access or receive information from the personalized patient medication management module. Therefore, one or more people can get information on the medication status of the patient and help fill prescriptions and/or pick up prescriptions or monitor if and when medication has been taken. Each of the modules may also permit the patient to disseminate select information within the respective module. Therefore, if the patient is reviewing a news feed or medication material through either the personalized self-care module and/or the personalized patient medication management module, the patient may push the information to one or more individuals or networks identified by the personalized support network module. A button or other push icon may be incorporated through the other modules that relate specific information and permit the information to be sent to the personalized support network.

The one or more modules may be separated, subdivided, deleted, duplicated, integrated, combined, and/or altered as necessitated by the system, application, patient, desired features, type of illness, etc. The presented system and modules are exemplary only and are not intended to be limiting. The system is described in terms of a client device communicating over a network with a database resident on a server. The client device may be a laptop, desktop, mobile device such as a smart phone, tablet, etc. One or more of the modules may be resident on one or more client devices and/or servers. One or more portions of the database may be resident on the client device and/or server and/or remote device. The system may interact with one or more client devices, such as through one or more patient client devices, social networked client device, caregiver client device, etc. The network may be a private or public network. For example, the client devices and server may communicate over the internet. The information may be encrypted such that the privacy and sensitivity of the information may be maintained.

The client device communicates the entered content through the user interfaces of the one or more modules to update one or more database attributes over the network to the server potentially located on the World Wide Web. A software program resident on the server takes in the details entered by the user. The backend server aggregates, consolidates, manages, saves, or otherwise manipulates the data and feeds this information back to the client device to be displayed on a display screen of the client device as well as possibly feed this information back to other users indicated by the patient, including the healthcare provider, social network, etc. as indicated by the patient preferences.

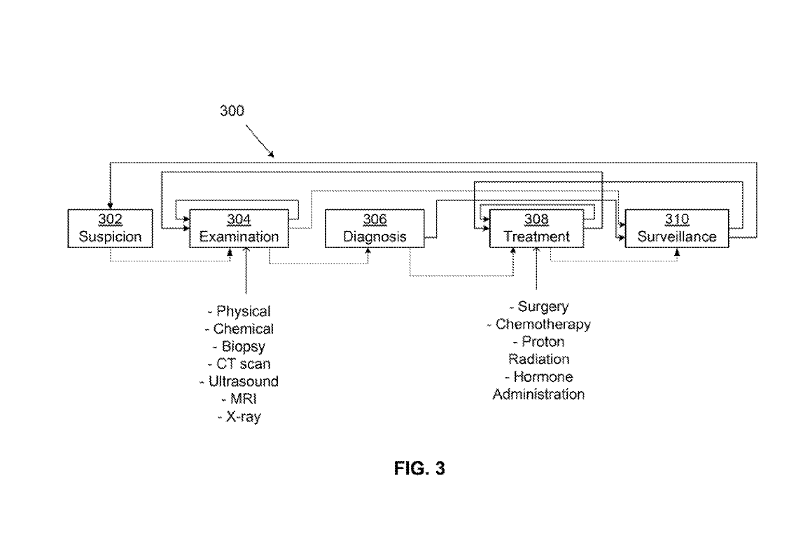

FIG. 3 illustrates an exemplary illness lifecycle 300 in which a patient may find themselves. For example, the illness lifecycle may include a suspicion of illness 302, examination 304, diagnosis 306, treatment 308, and surveillance 310. Each of the lifecycle steps may include various alternatives depending on the illness and/or characteristics of the patient.

The cycle may be repeated through one or more steps or may occur in various order and advance at varying timing intervals. The progression may depend on the type of cancer, the stage of diagnosis, the patient conditions and attributes, among any number of other personal, environmental, social, and other conditions. Therefore, it is generally difficult for any system to actually track and/or anticipate the progression of an illness specifically tailored for any one patient. For example, various potential progression paths are illustrated by the various connecting arrows between the lifecycle stages. Moreover, as indicated below select representative steps, one or more options to perform the step may also subdivide or further complicate any progression through the lifecycle.

In the exemplary case of breast cancer, the patient may have a suspicion of illness 302. The suspicion may be based on one or more symptoms observed at home, by a treating physician, or by friends or family. The patient may then have an examination 304 to confirm the presence of one or more identifiers indicative to the suspected cancer. In the case of breast cancer, physical examination such as palpation of the area may determine the presence of a suspected lump. Chemical tests on patient fluid samples may indicate the presence of other relevant identifiers. Other examination procedures may be used, such as a biopsy, one or more scans or imaging techniques, including ultrasound, computerized tomography (CT) scan, magnetic resonance imaging (MRI), x-ray, etc. One or more trained professionals at one or more facilities may be used to administer the respective examinations and their information provided to either the patient or their primary care practitioner. From the various results, the primary care practitioner may provide a diagnosis, at step 306, such as the identity of breast cancer and may determine the stage of advancement.

Depending on the identity of the illness, characteristics of the patient, the advancement of the disease, and other factors, the practitioner may implement a treatment plan 308 or may decide just to watch the condition 310. Treatment plan 308 options will depend on the illness and the patient. For example, treatment options for cancer may include chemotherapy, proton radiation, surgery, hormone administration, etc. The various treatment combinations depend on a specific illness and patient, and therefore make the progression through treatment plan very difficult to track and anticipate. For example, a typical cancer patient may first attempt surgery to remove a primary concentration of cancer cells, and then undergo chemotherapy to irradiate any remaining cells. However, another patient may experience a tumor that is too large to extract initially. In this case, the patient may first undergo chemotherapy to shrink and localize the tumor, then extract the tumor through surgery. Therefore, a treatment plan designed for the typical patient would not address the concerns and situation of all cases. Again, the treatment options may include one or more specialists or skilled practitioners at one or more different locations. The patient may also undergo surveillance 310 at any stage of the lifecycle to observe how the patient reacts to different treatment options and/or determine the course and aggressiveness of the illness.

In the exemplary case of breast cancer, the illness lifecycle may, for example, include one or more of the following steps: The suspicion of illness 302 may include a presentation of a lump. The examination 304 and diagnosis 306 may include a practitioner visit to confirm by physical palpation the presence of a lump and then a biopsy. The diagnosis is established once the pathology results are received. A medical oncologist may then be required to confirm the diagnosis and assess the advancement of the cancer. For example, the cancer may be early stage, locally advanced, or metastatic. Exemplary treatments 308 may include, for example, chemotherapy, radiation therapy, or hormone therapy. After active treatment is complete, the patient may undergo surveillance 310 or other activity such as prevention, or palliative care.

During this lifecycle, the patient may have questions about possible treatments, expected outcomes, associated medications and side effects, among others. The patient may also want to disseminate and coordinate information to family members and friends. Other people may want to participate and support the patient such as family members, friends, and other support networks. The patient may also have one or more people assisting or coordinating their care, such as monitoring symptoms, medications, appointments, etc. The patient may also desire to track their symptoms and/or progress. For example, the patient may want to track dietary intake, weight, medications, symptoms, temperature, among other biological, physiological, or personal indicators, conditions, symptoms, etc.

Embodiments described herein may assist the patient through their illness lifecycle. As shown and described, a mobile application may be provided to a patient with one or more modules configured to assist the patient with one or more features described herein. The patient may download the application on any mobile device or access the application from a web browser.

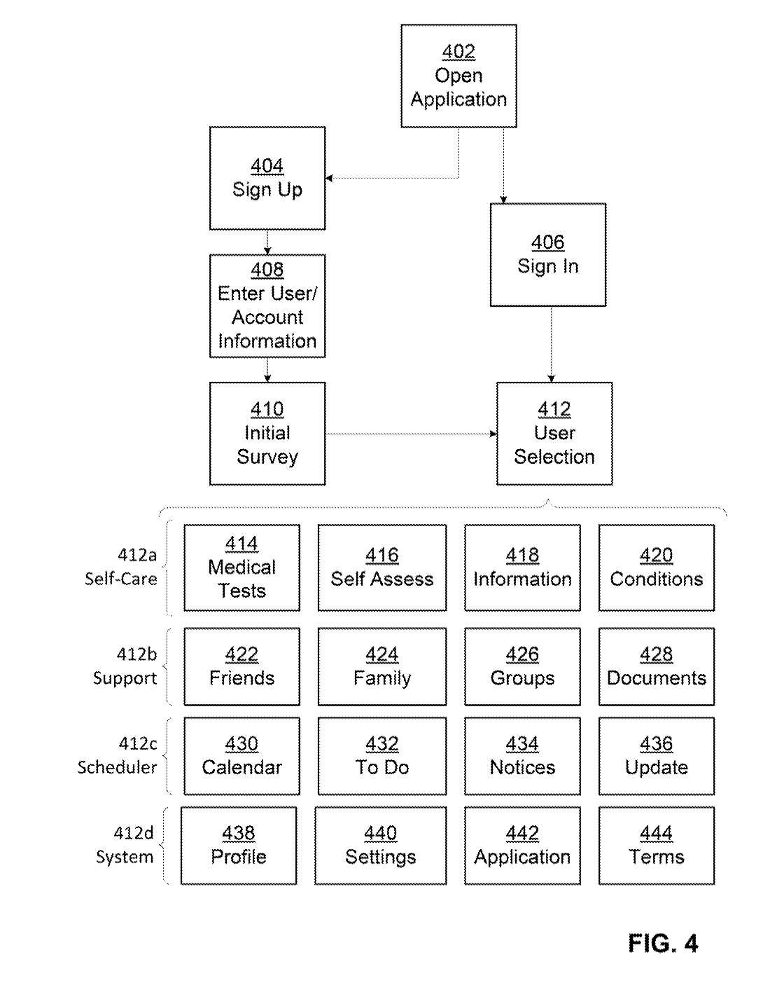

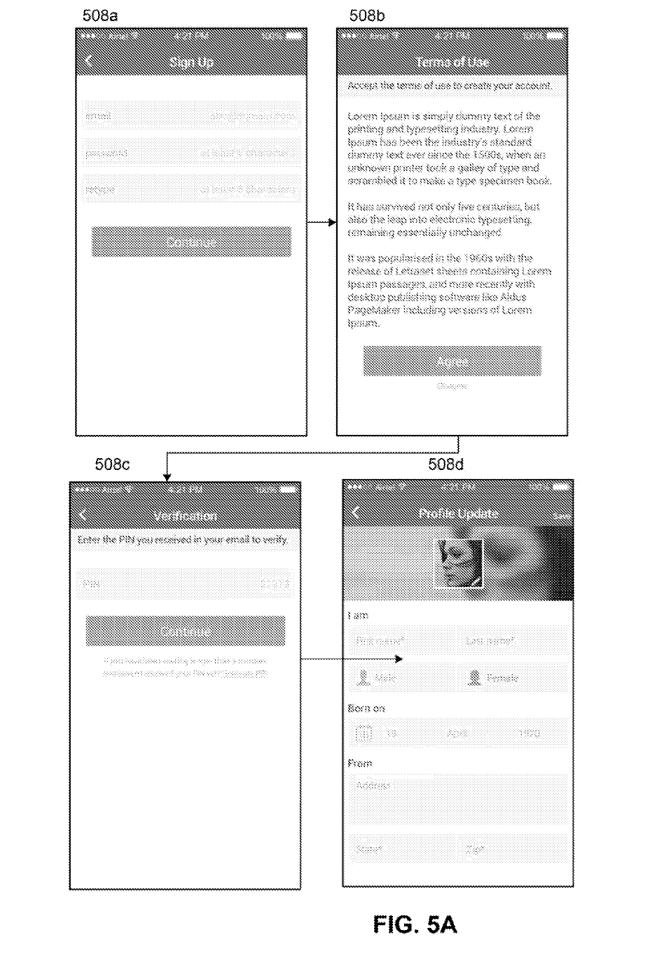

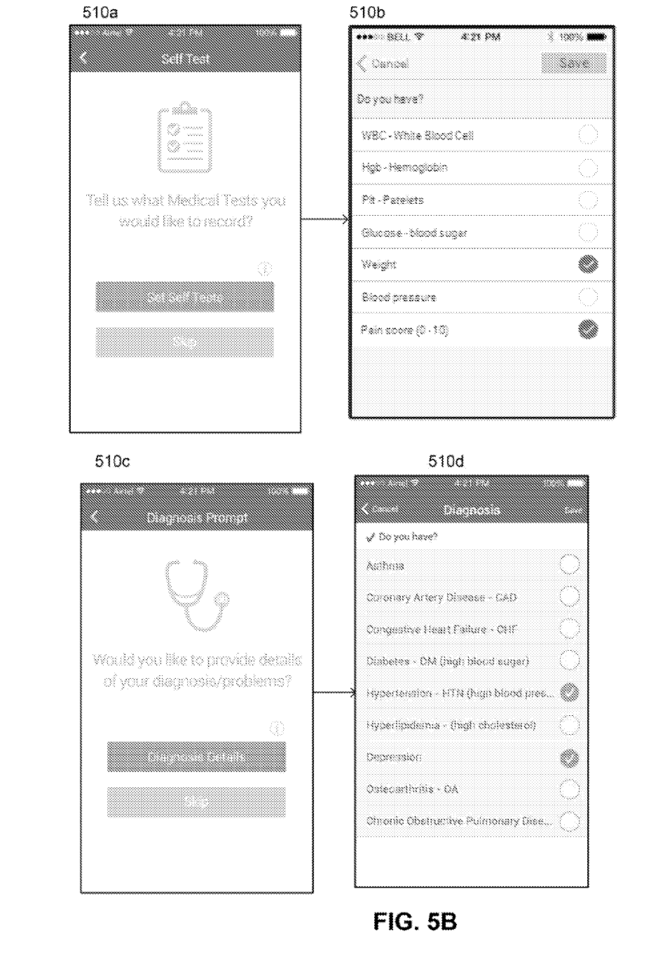

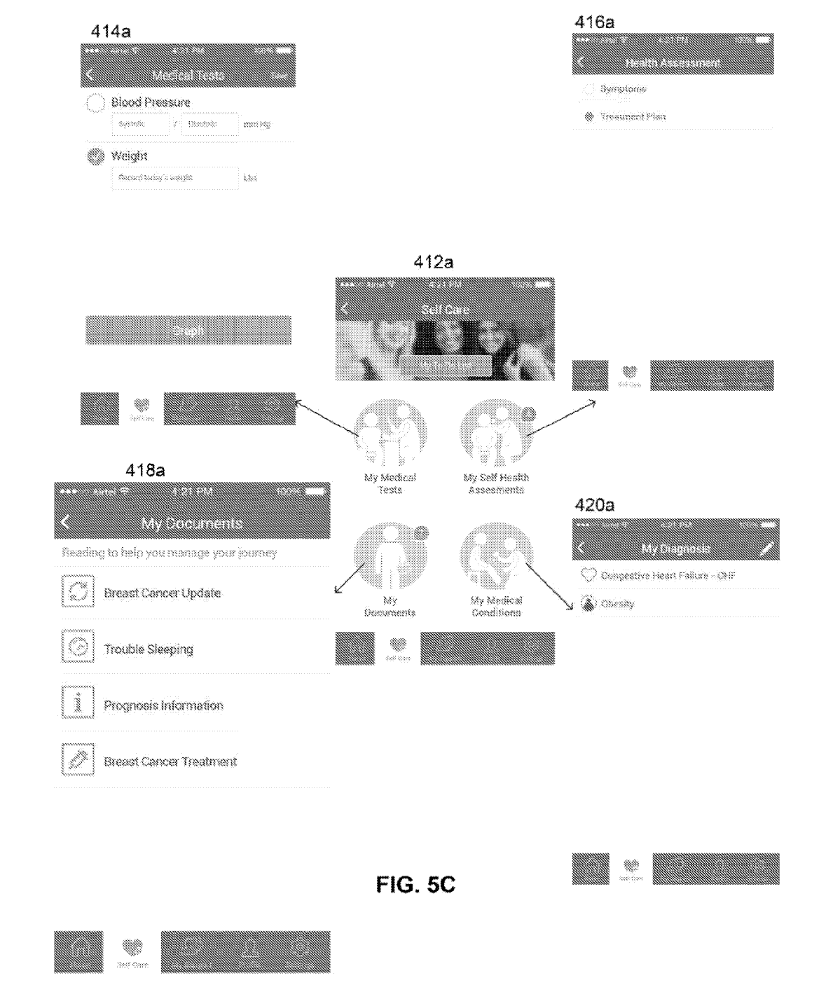

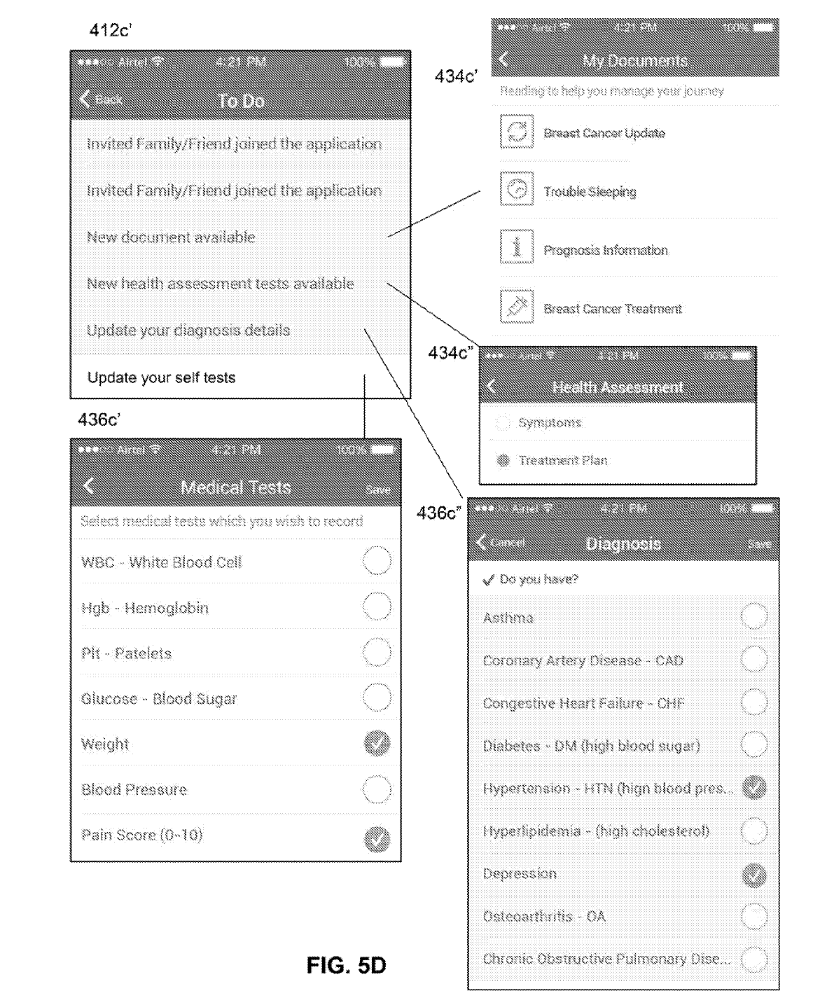

FIG. 4 illustrates an exemplary method 400 of using the application to assist a patient using one or more features of the application described herein. FIGS. 5A-D illustrate exemplary application modules and user interfaces corresponding to the method of FIG. 4. In a first step, 402, the patient may launch or open the application. For example, the patient may have downloaded an application onto a mobile device and launched an icon from the mobile device. In this case, the application may be stored as non-transitory machine readable media within memory on the mobile device and executed by a processor of the mobile device. The patient may also navigate to a website hosting the application stored on a remote server and accessible through a browser. The application may comprise a user interface displayed to the patient to navigate the system.

Through the user interface, the patient may select to sign up 404 or sign into 406 the application. If the patient selects to sign up 404, the patient may be presented with one or more fields to initiate the application. The information may include user name, email, password, name, etc. For example, as shown in FIG. 5A, the patient may be presented with one or more user interface screens, 508a-508d, to provide and receive information from the application. A first screen 508a may permit the user to sign up by providing a login name, email, and password. The patient may also be presented with notices, policies, or legal obligations, 508b, such as terms of use, software license, privacy policies, etc. The system may also include one or more security features 508c before permitting a user to sign up. For example, a verification of identity or entered information may be required to limit fictitious users. The patient may then be provided with a user entry interface 508d, profile update, in which the patient may provide personal information including, for example, name, gender, birth date, address, etc.

After creating the account, the user may be presented with an initial survey 410 to determine their location on the illness lifecycle. The survey may include one, two, or more sections in which the patient may be presented options to identify or determine a stage of the illness, for example, by entering in symptoms, and/or professional diagnosis by providing information received by one or more practitioners and/or tests, scans, or other information received during an examination, step 304 of FIG. 3. In an exemplary embodiment, as seen in FIG. 5B, the patient may be prompted to perform a self-test 510a, in which the patient can identify and/or enter in specific information about their condition and symptoms. For example, if the patient is experiencing pain, or has recently weighed themselves, received or performed a blood pressure test, or taken a glucose-blood sugar test, the patient may enter in associated information with respect to the information and/or symptoms experienced. The patient may also be prompted for one or more diagnosed conditions 510c, and be permitted to identify one or more conditions 510d presently experienced by the patient. Conditions may include other illnesses, diseases, or condition related to or extraneous to the present condition in which the application is assisting the patient. For example, if the patient currently suspects breast cancer, the system may still prompt the patient to identify whether they have or had asthma, diabetes, hypertension, or other condition that may influence the path or trajectory through the patient's journey of the illness lifecycle.

The system may also prompt the user to take advantage of one or more other option in or option out features, such as receiving specific specials or information, participating in clinical trials, finding support groups, etc. These services may be separate from or integrated into the patient experience system described herein. For example, the patient may elect to be part of clinical trials covering their condition. The system may either identify registries or other information for the patient to sign up for such opportunities, or the system may facilitate and/or directly communicate with or provide patient information to one or more clinical trials actually being performed. The system may therefore be integrated or interface with these other programs to receive information about the trials and condition of the patient, such that the patient experience may be fully integrated and updated by one or more providers assisting in the care of the patient.

In an exemplary embodiment, the patient may be presented with one or more questionnaires or maps to determine information relevant to the patient. The questions may elicit what information the patient may desire to receive or their current understanding or awareness level of their present illness and associated stage. For example, the patient may be asked if they have a good understanding of what their illness is, what are the risk factors, whether they have any risk factors, whether they know of anyone with the illness, whether they engage is certain activities that may impact their illness, or whether they want specific information about related topics such as nutrition, anxiety, depression, pregnancy or infertility, etc. Depending on the answers, the system may select one or more information disclosures to provide the patient. The system may also request or receive information additional information related to responses provided by the patient. For example, if select persons are known to have had the illness, the system may specifically prompt the user to add persons to their support network as described in more detail below.

In an exemplary embodiment, the system interacts such that information entered at one interface may populate or otherwise activate action at another interface. For example, if the patient answers that an appointment is scheduled, such as a biopsy or surgery, then the system may request at a later stage or through one or more other interfaces that the appointment information needs to be entered. The system may then request the date and track the date for the patient. The system may be used to calendar the date, provide reminders to the patient, or alert other users to the date. The system may also use the date to trigger information released through an information interface to provide relevant information to the patient at a pertinent time relative to the scheduled appointment. Therefore, if an appointment is not scheduled for weeks, the system may provide reminders days in advance, provide associated information proximate the appointment time, and provide follow up questionnaires after the appointment. Relevant information may include glossary terms, procedure summaries and descriptions, pre- and post-procedures, etc.

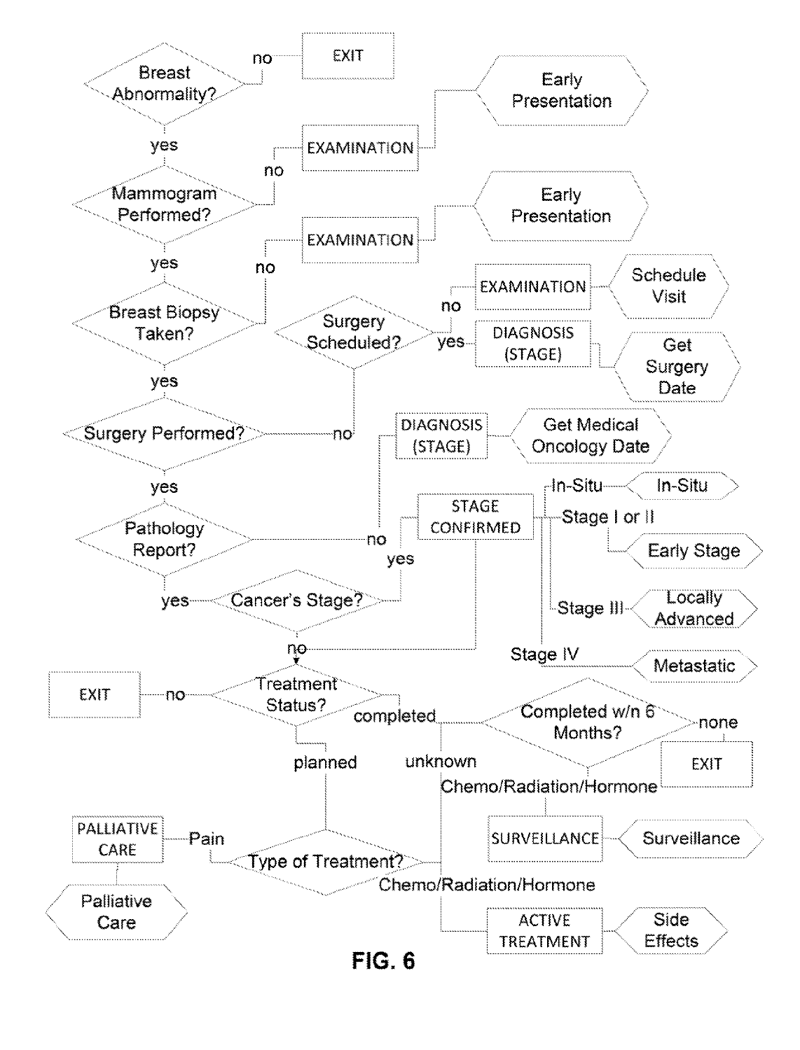

In an exemplary embodiment, a mapping module may be used to facilitate the entry of information and progression of the patient through the illness lifecycle. FIG. 6 illustrates an exemplary entry survey map that may be navigated to determine the stage of a patient's breast cancer upon initiating or setting up the application. Each question may be presented as an easy to answer yes or no question or a selection of one or more choices that the patient may view and respond to on the user interface. Depending on an answer to a question, the survey will prompt the next appropriate question such that the presentation is dynamic based on the preceding answers. If the patient has found a breast abnormality, had a mammogram performed, but not had a biopsy taken, then the patient is still in the examination portion of the lifecycle to determine a diagnosis. The patient then may not need to answer any more questions regarding whether the cancer's stage is known or what treatment is planned, since the patient has not journeyed through the lifecycle yet, and would not know.

From the entry survey, the mapping module can determine where the patient is on the illness lifecycle. The information relevant at the specific stage may also be provided to the patient, as well as an assessment of what the next stage is likely to be, and/or the next assessment to be provided the patient to track the patient to the next lifecycle step. For example, as shown in FIG. 6, and exemplary entry mapping may provide a patient one or more questions, generally represented by the diamonds. Depending on the answer provided by the patient, another question may be selected, as indicated by the progress to another diamond, or the stage may be determined, as indicated by the rectangle. Depending on where the patient's progress is determined to be, the patient may be provided specific information about the present and/or previous stages of their journey. The next anticipated progress point or an indication of which map to use next to track the patient to their next progress point, as indicated by the hexagon, may also be determined by the mapping module. Information associated with the next map or anticipated progress point may also be provided to the patient to prepare them for their coming journey.

Therefore, once inside the application, the patient may be provided specific, selected information, tailored to their location on the journey. The application's interface and prompts that the patient receives may similarly be tailored to their location on the journey, such that the application may attempt to solicit important information that the patient may otherwise overlook, forget, etc. For example, if the patient indicates they are presently undergoing treatment, then the scheduling management module may prompt the user to track certain parameters that may indicate certain adverse side effects; or the personalized patient medication module may prompt the patient for a medication schedule and then remind the patient to take medications at regular intervals. The system may therefore assist the patient in gathering, recording, or maintaining their own information to present to their practitioner at the next visit. The system may also assist in organizing, scheduling, and maintaining lists, actions, information, etc. associated with their condition, treatment, or otherwise.

Once inside the application, the mapping module may also provide other maps to the patient initially or along the patient journey. The subsequent maps may be automatically generated at set locations along the journey, time intervals, or may be dynamically generated depending on the patient's or other user's input to the system, such as through mapping questionnaires, entry into one or more modules, such as personal information, symptoms, appointments, etc., or may be selected at the discretion of the patient.

Referring back to FIG. 4, after the patient has concluded the initial survey 410 including one or more entry maps, surveys, or questionnaires, or if the patient has signed into an already created account 406, the patient is presented a user interface to navigate the application. The user interface is configured to permit the patient to make a user selection 412. The user selection may be presented in one or more buttons, icons, text, drop downs, or other interface presentation features that presents information and receives inputs from a user. As illustrated, for example in FIG. 5C, the patient may be presented with icons grouped or categorized on tabbed pages. As shown, the grouping may be any that is logical to a user, such as by self-care 412a, support networks 412b, scheduling 412c, and system 412d.

An exemplary self-care 412a category is illustrated in FIG. 5C. The exemplary self-care category permits the user to provide and retrieve information regarding their own maintenance of their condition. The self-care category may include such features as receiving and providing information about self-administered medical tests 414, other self-assessments 416, information regarding their condition 418, or a statement or log of the patient's conditions 420. As illustrated, the medical tests 414 may be entered through a user interface 414a that permits a user to make one or more measured tests and enter information into the application. For example, the patient may be self-testing blood pressure, blood glucose, weight, etc. Other self-assessments 416 may similarly be entered through a user interface 416a, and permit a user to enter symptoms such as appetite, mood, pain, sleep, tiredness, or other indicator and provide an associated time, frequency of occurrence, and/or suspected triggering condition. The patient's conditions 420 may be entered through an associated user interface 420a that permits the user to select one or more conditions for which the patient has been diagnosed, or for which the patient suspects. Information 418 may also be provided to the user to inform the patient on their condition, symptoms, treatment, support, etc. as determined by embodiments of the system described herein. Therefore, as illustrated in an exemplary user interface 418a, relevant information is presented to the user concerning their immediate situation tailored specifically to their condition and progress.

In an exemplary embodiment, the system may comprise a self-care module that receives and returns information from and to a patient regarding their illness. The self-care module may, for example, permit a user to indicate which medical tests they self-administer, provide reminders to administer a test, and receive data regarding the respective test. The self-care module may use information received in conjunction with the mapping module to specifically identify information relevant to the patient, and/or update the patient's progress through the illness lifecycle. The self-care module may also visually display tracking information regarding the patient's condition and/or tests. For example, the self-care module may present a graph of the patient's self-administered test results over a period of time. The patient can therefore visually see the progression of their condition on one or more health parameters. This information can also be easily sent or shown to a practitioner to efficiently convey one or more details regarding the progress of the patient's condition. The self-care module may similarly include one or more algorithms that may suggest associations between observed or received information. For example, if the patient is entering in symptoms such as nausea that occurs at specific times after other information provided to the system such as an administration of medication, then the self-care module may suggest to the patient an association or correlation of one action to an observed result. The self-care module may communicate to another module, such as the scheduling module to remind the patient to discuss this specific issue with their practitioner on their next visit, or may provide or request whether the patient wants to receive information about the specific side effects of the observed correlated treatment.

The user may also track one or more scheduling events 412c trough a user interface as illustrated in FIG. 5D. The scheduler 412c may include such features as a calendar 430 that permits a user to enter and be reminded of appointments, medications, or other events. The calendar 430 may coordinate or communicate with one or more other personal calendars of the patient, such as Outlook®, Google®, etc. The calendar may also coordinate with other systems such as pharmacy or practitioner systems to schedule events between multiple parties. For example, the calendar may coordinate scheduling of appointments, or refill of medications.

The scheduler 412c may also include a to do list 412c′ as illustrated in an exemplary user interface of FIG. 5D. The to do list may be used to provide one or more notices 434 to the patient or the notices 434 may be separately presented to the patient. For example, notices 434 to a patient may include new available documents 434c′ or new health assessments 434c″ that the patient may undertake or review. Updates 436 may also be included through the task list or separately to a patient, such as to permit a user to update the self-assessment tests 436c′ they perform or to update their diagnosis 436c″. The to do list may be automatically updated based on other inputs or events of the system. For example, if the patient was expecting biopsy results, the to do list may automatically request the patient to update their diagnosis details to include the results of the test. Once the diagnosis details are updated, the system may then determine additional information to provide to the patient. The to do list may then indicate new documents available for review concerning the new diagnosis. Similarly, the system may prompt the user to periodically or based on their illness lifecycle update their self-test assessments, or other inputs of the system.

In an exemplary embodiment, the system may comprise a scheduling module to implement the features of the calendar, lists, notices, and updates, as described herein. The mapping module may also interface with the scheduling module such that the necessary mapping questions are answered as to do list items. The system may therefore progress the patient through their illness lifecycle in an integrated and efficient manner. Relevant information is therefore continuously supplied to the patient as the patient reaches certain times, progressions, or milestones in their illness lifecycle.

The user may also select to navigate to the support 412b portion of the application. The support 412b portion may, for example, include one or more networks of people such as friends 422, family 424, groups 426, and shared documents 428. The system may permit a user to enter, update, and communicate with one or more persons of their one or more networks. For example, groups 426 may include public or private groups in which the patient is involved. The private groups may be individuals selected from their one or more other networks of friends and families, such that the selected group can have a shared interaction with the patient. Documents 428 may be sent to one or more of the individuals or groups for disseminating relevant information or facilitating discussions between the respective persons. For example, a patient may receive information on a proposed treatment option through the self-care module. The patient may select this document to send to one or more individuals for discussion. The document may then be made available to the persons indicated by the patient, and a discussion group may be created around the document. For example, a shared chat space may be created such that each person can enter text and receive text from others in the group. The group may similarly see and/or annotate the provided document to highlight specific information to facilitate the discussion.

The patient may also select to view or update system features 412d. System features may, for example, include the patient's profile information 438, system settings 440, application details 442, or terms or conditions of use 444. Patient profile may include such settings as name, user login, password, or other account details, such as email, gender, age, etc. System settings may permit a user to customize the application such as through user interface selections, turning on and off features, update previous selections such as whether to participate or receive information about clinical trials or to include your data in research pooling. Application details 442 may provide the patient with details regarding the specific application or program they are running including versions, permissions, etc. Terms or conditions of use 444 may also be made available so the patient can be reminded of their use obligations or rights, such as privacy statements.

As shown and described, a personalized patient experience system is provided. Embodiments described herein may also be used by one or more other users to provide and receive information from the patient. For example, a practitioner system may include one or more modules that permit a practitioner to send or receive information with a patient. The practitioner system may not include all of the information available to the patient, for example, may not include the self-care module as the practitioner may not be administering their own tests or want to receive updated information about the progress of all of the patients. However, the patient may permit the practitioner to submit information on medical tests, or to view results from the self-care module as updated by the patient. Similarly, users from the support network may also use one or more attributes of the system to receive and disseminate information with a patient. The support users may include one or more attributes such that they may participate in receiving and providing information, discussion groups, receiving or submitting updates on schedules or medications, etc. The level of access provided each user may be set, monitored, and updated by the patient as appropriate, such that one or more other users participates in the patient's care to the desired access level of the patient.

As shown and described, embodiments described herein may be used to track a patient through an illness journey and provide and anticipate the progression of the patient illness in the form of one or more modules configured to provide the patient information and assistance in various forms for their present stage and one or more anticipated future stages tailored to the patient. Embodiments described herein may be used to efficiently consolidate the patient's symptoms and progress, coordinate and organize communication with support networks, individuals assisting in the patient's care, practitioners, and others involved with the patient.

Being diagnosed with cancer is one of the most shocking things that can happen to a person and their family. Even though it is not necessarily life threatening, a diagnosis of any type of cancer is extremely emotional. In addition, the complexity of the healthcare system is overwhelming which causes even more difficulty for patients and families. Patients and family are often overcome with fear of the future, fear of the unknown and a general lack of understanding of the diagnosis, the treatment and the path to survivorship. Accordingly, embodiments provided herein may provide an easy to use, intuitive “app” that help patients by creating personalized self-care programs, personalized education, support networks and healthcare system collaboration. Leveraging intuitive and easy to use apps, embodiments described herein may be used to provide emotional and “healthcare system” support to cancer patients by informing, educating, and facilitating collaboration, easing the challenges of a very difficult time in life.

Upon diagnosis, one of the first things a patient might consider is to search the internet for information, but unfortunately a lot of information available on the internet is either inaccurate or inapplicable for the specific patient circumstance. Communication and collaboration with healthcare professionals is often difficult due to schedules or general physician availability. Understanding bills, costs of treatment, how to schedule appointments, with who and when, is also often a confusing factor for individuals that likely have been healthy up until the time of their diagnosis. Embodiments described herein may therefore address many issues of these patient experiences and provide easy to use, intuitive solutions that help patients, as well as their friends and family, cope with emotional challenges, understanding of their specific diagnosis and treatment, and support interaction with the healthcare system.

There may never be a time in a person's life when they need support more than when they have been diagnosed with cancer. Using embodiments described herein, the patient's , their caregivers, their families and their friends emotional, clinical and social needs may be supported. Embodiments described herein may empower: Communication and collaboration directly with physicians, case managers, cancer navigators and other healthcare professionals; facilitation and maintenance of complex treatment programs—even while patients are at home; initiation and conducting of personalized Self Care activities; undertaking of self-test reporting; viewing of personalized multi-media and other educational content—supporting the patient, caregiver, family and friends in understand the diagnosis, treatment and recovery process; easy management of appointments and payment of bills; and any combination thereof or described herein. Patients therefore get answers to their most urgent questions, all in an intuitive interface accessible from any computer or smart mobile device.

With healthcare affordability reforms coming quickly, maintaining relationships with patients over the long term will be critical for healthcare providers. Organizations that provide support to patients are likely to experience higher patient satisfaction, higher degrees of recruitment as well as higher patient retention. Patient facilitated appointment and billing management may result in fewer “no-shows” for appointments and more on-time and complete bill payment. Patients managed under a “bundled payment” program may also have a better mechanism to interact with the healthcare providers in a manner that will maintain quality of care, but reduce the cost of providing care. As a result of the higher on line interaction with patients, physicians and healthcare organizations may also have access to currently unavailable patient self-reported data, improving outcomes analysis, and permit other analytics options. This data may provide valuable input into ongoing refinement into post-acute care protocols, leading to fewer readmissions.

Maintaining a collaborative environment for physicians and clinicians is difficult. With increasing workloads there is even less time to spend with each patient. Unfortunately this leads to a lot of unanswered patient questions, sometimes leading to frustration on the part of both the physician and the patients. Further, monitoring of medications, medication compliance, toxicity and other potentially life threatening complications is increasingly difficult. By facilitating appropriate data connection while the patient is home or in the community, embodiments described herein may facilitate a higher level of collaboration and understanding of patient condition by the physician, clinicians and navigators. Not only does this enable better collaboration when the patient is not in the physician's office, but it provides a more complete picture of the patients status when they are. Embodiments described herein may also provide solutions that facilitate easy sharing of clinical and other patient related information, while maintaining patient control. This way the entire team that is actively engaged in the management of the patient has a more holistic picture of the patient status, and thus may be more effective and efficient in their care delivery.

Accordingly, although embodiments described herein are for patient's managed care, there is also significant derivative value to a number of stakeholders within the healthcare system. Healthcare systems will benefit from improved patient engagement, and “loyalty” to being treated in their facility. Physicians will be better able to understand the patients' clinical, social and emotional status even while they are outside the healthcare system.

While some specific embodiments of the invention have been shown the invention is not to be limited to these embodiments. For example, most functions performed by electronic hardware components may be duplicated by software emulation, and vise verse. Thus, a software program written to accomplish those same functions may emulate the functionality of the hardware components in input-output circuitry. The invention is to be understood as not limited by the specific embodiments described herein, but only by scope of the appended claims.

For example, exemplary embodiments are provided in terms of one or more modules. These modules are explained as separate operating units for simplicity and are not intended to be limited to the features described. Instead, features of one or more modules may be combined, separated, integrated, or otherwise redefined in any configuration to perform one or more functions described herein. For example, the scheduling module is shown and described that encompasses different functions such as calendaring, organizing and presenting tasks or to do lists, providing updates and/or notices. However, similarly described is a patient medication module that coordinates medication of a patient that may use similar functions as the scheduling module. Therefore, different modules may perform one or more of the desired functions. The scheduling module may therefore encompass, combine, include, or supplement the medication module or vise verse. Different features of the scheduling module may be presented through the medication module such that the functions are segregated and different. Alternatively, the modules may be combined and integrated so that the two described modules are performed by a single module. Similarly, as recited in the claims, the indication of a first, second, or other module is intended to distinguish functions of modules and does not indicate a quality or separate entity. Instead, as long as one or more modules are present including the recited functions, the first, second, or other module is present in the system.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

The invention claimed is:

1. A personalized patient experience system, including a webpage resident on a server or a native mobile application resident on a client device configured to communicate with the server, where the webpage or native mobile application is configured to receive input from a patient through one or more interfaces and communicate the received input to the server, where the server is configured to cooperate with a database over a network, where the system comprises:
a first module to receive information from the patient about an illness of the patient; and
a second module to disseminate information to one or more users about the illness of the patient,
where the system monitors the received information to determine what information should be disseminated to each user.

2. The personalized patient experience system of claim 1, where the one or more users comprises the patient.

3. The personalized patient experience system of claim 1, further comprising a mapping module configured to determine a location of the patient along an illness lifecycle and at least periodically update the location of the patient along the illness lifecycle to a progressed location based upon updated information received from the patient.

4. The personalized patient experience system of claim 3, wherein the second module is configured to disseminate information related to the location of the patient along the illness lifecycle proximate to a transition of the patient through the location.

5. The personalized patient experience system of claim 4, wherein the second module is configured to update disseminated information related to the progressed location of the patient when or after updated information is received from the patient.

6. The personalized patient experience system of claim 5, wherein the second module is configured to disseminate information to one or more users selected by the patient.

7. The personalized patient experience system of claim 6, wherein the patient creates a discussion group of more than one user to permit the users of the discussion group to submit text to the other users and receive text from the other users.

8. The personalized patient experience system of claim 7, wherein the patient can select a document disseminated by the second module and send to the discussion group.

9. The personalized patient experience system of claim 1, further comprising a personalized patient medication management module configured to present a user interface to retrieve and disseminate information regarding medication management.

10. The personalized patient experience system of claim 9 wherein the personalized patient medication management module sends reminders to a patient about medication times and permits a patient to confirm whether a medication was taken.

11. The personalized patient experience system of claim 10, wherein the personalized patient medication management module alerts another user of medication times or prescription renewal times of the mediation.

12. The personalized patient experience system of claim 1, further comprising a medical bill payment module configured to present a user interface to retrieve and disseminate accounting information associated with a treatment of the illness of the patient.

13. The personalized patient experience system of claim 1, further comprising a personalized self-care module configured to present a user interface to retrieve and disseminate information regarding a patient's condition associated with the illness.

14. The personalized patient experience system of claim 13, wherein the self-care module is configured to receive a measured value from the patient about a first condition of the patient.

15. The personalized patient experience system of claim 14, wherein the measured value is one of blood pressure, weight, and blood glucose.

16. The personalized patient experience system of claim 14, wherein the self-care module is configured to displace a sequence of measured values received from the patient over time about the first condition.

17. The personalized patient experience system of claim 13, wherein the self-care module is configured to receive a qualitative measurement from the patient about a second condition of the patient.

18. The personalized patient experience system of claim 17, wherein the second condition of the patient includes one of a quality of sleep, appetite, pain, or mood.

19. A method of assisting a patient through a lifecycle of an illness, comprising:
receiving from the patient specific patient information including patient attributes and illness progression attributes into a personalized patient experience system accessed through an electronic mobile device;
determining a progression of the patient along the lifecycle of the illness;
providing patient specific information about the illness commiserate with the progression of the patient along the lifecycle of the illness;
updating the progress of the patient along the lifecycle to an updated progression upon receiving update information through the electronic mobile device; and
providing updated patient specific information about the updated progression upon or after receiving update information.

20. The method of claim 19, wherein providing patient specific information is correlated in time to the progression of the patient along the lifecycle of the illness, such that information is provided in an approximately appropriate time relative to the progression of the patient along the lifecycle of the illness and is determined based on the specific patient information including the patient attributes.
